(19) United States
(12) Patent Application Publication
(10) Pub. No.: US 2004/0251677 A1
(43) Pub. Date: Dec. 16, 2004

(54) Loose leaf device

(76) Inventor: Rong Chun Tseng, Tai Ping City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/458,684

(22) Filed: Jun. 11, 2003

(51) Int. Cl. B42D 1/00

(52) U.S. Cl. 281/27.1

(57) ABSTRACT

A loose leaf device comprises a plurality of assembly units and a plurality of sheets of papers. Each assembly unit has a round shape and a periphery of each assembly unit has an annular ring. A center of each assembly unit has a via hole and an inner ring is protruded from an inner wall of the annular ring. Each paper has a plurality of through holes and slots. Each through hole and each slot are correspondent to the annular ring of the assembly unit. Each slot of the paper is communicable to the outer side of the paper by a slit. The inner buckles are formed at the edges of the slot and outer stoppers are formed at the edges of the slit. Moreover, the paper can be replaced a plurality of thin pocket sheets, each sheet can receive photographs, compact disks, etc.

### FIELD OF THE INVENTION

The present invention relates to loose leafs, and particularly to a loose leaf device which has a novel design structure so that the loose leaf has a firm structure which is tolerable for a tearing force applied thereon.

### BACKGROUND OF THE INVENTION

Referring to FIGS. 1, and 2, the prior art assembly device for assembling papers is illustrated. The assembly device 10 is a round plate 12. An annular ring 11 is arranged on the periphery of the round plate 12. Each paper is formed with a plurality of through holes 21 corresponding to the annular rings 11 and slots 22 corresponding to the round plate 12. Two sides of the slots 32 are formed with buckling pieces 23. Thereby, the assembly units 10 and the papers 20 are assembled by the through holes 21 and the slots 22. The annular ring 11 of the assembly unit 10 resists against the buckling pieces 23 so that the paper 20 is firmly secured therein. However above said prior art has the following defects.

If a tearing force is applied to the paper 20, the stress will concentrates on the connection portion of the buckling pieces 23 and the through hole 21, and thus the buckling pieces 23 will break, as shown in FIG. 3. The plate 12 of the assembly unit 10 is a close shoot without any via hole formed therein so that the user of the assembly unit 10 is confined.

### SUMMARY OF THE INVENTION

Accordingly, the primary object of the present invention is to provide loose leaf device which comprises a plurality of assembly units and a plurality of sheets of papers. Each assembly unit has a round shape and a periphery of each assembly unit has an annular ring. A center of each assembly unit has a via hole and an inner ring is protruded from an inner wall of the annular ring Each paper has a plurality of through holes and slots. Each through hole and each slot are correspondent to the annular ring of the assembly unit. Each slot of the paper is communicable to the outer side of the paper by a slit. The inner buckles are formed at the edges of the slot and outer stoppers are formed at the edges of the slit. Moreover, the paper is replaced a plurality of thin pocket sheets, each sheet can receive photographs, compact disks, etc.

The various objects and advantages of the present invention will be more readily understood from the following detailed description when read in conjunction with the appended drawing.

### BRIEF DESCRIPTION OF THE DRAWINGS

FIG. 1 is a partial exploded view of a prior art design.

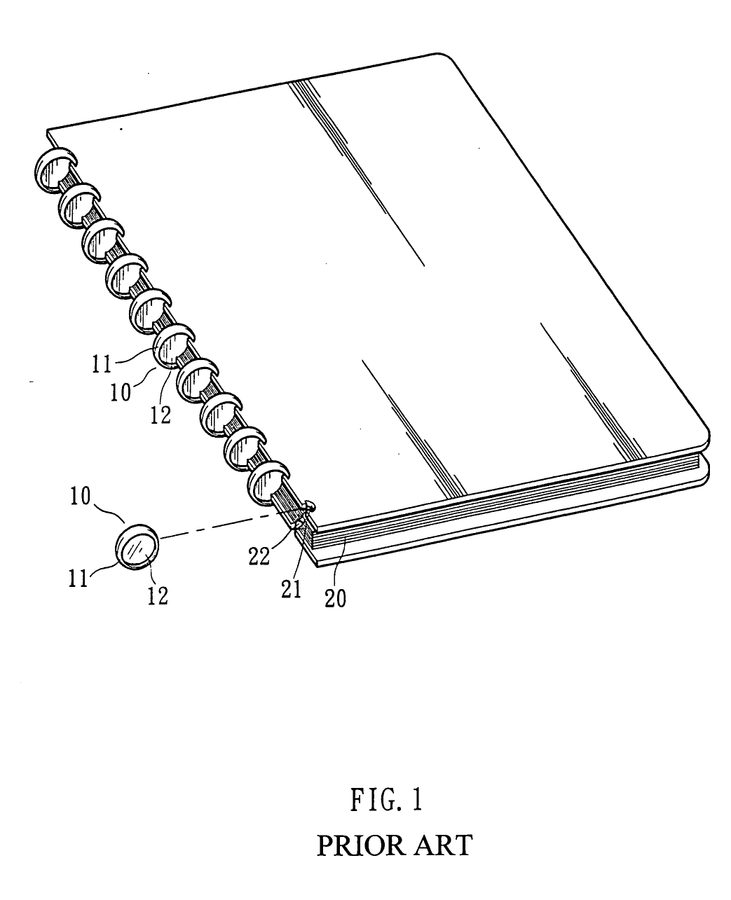

FIG. 2 is an elevational view of the prior art design.

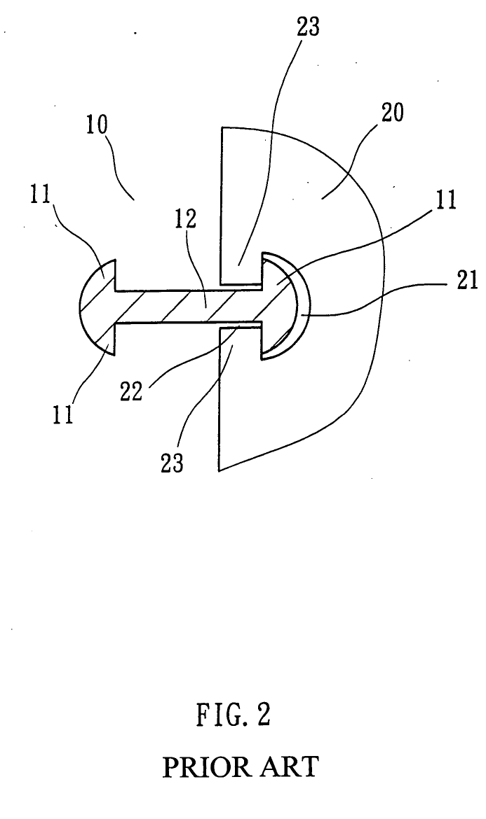

FIG. 3 is a schematic view showing one condition occurring in the prior art.

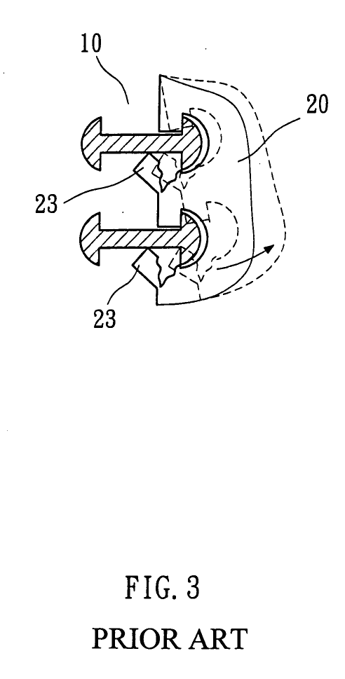

FIG. 4 shows one perspective view and partial exploded view of the present invention.

FIG. 5 is a cross section view and a partial enlarged view of the present invention.

FIG. 6 shows one application of the present invention.

FIG. 7 shows another embodiment of the present invention.

### DETAILED DESCRIPTION OF THE PREFERRED EMBODIMENTS

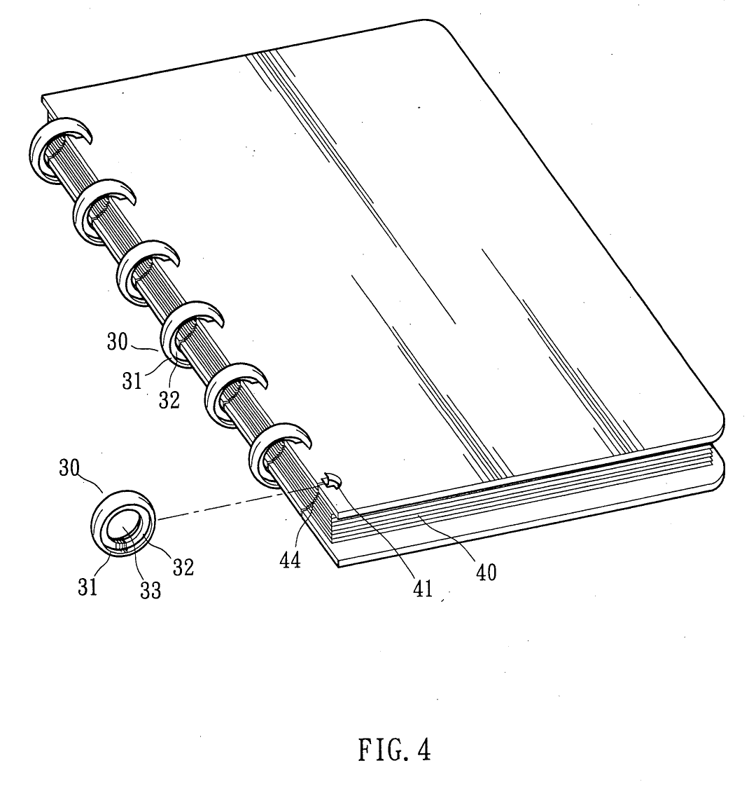

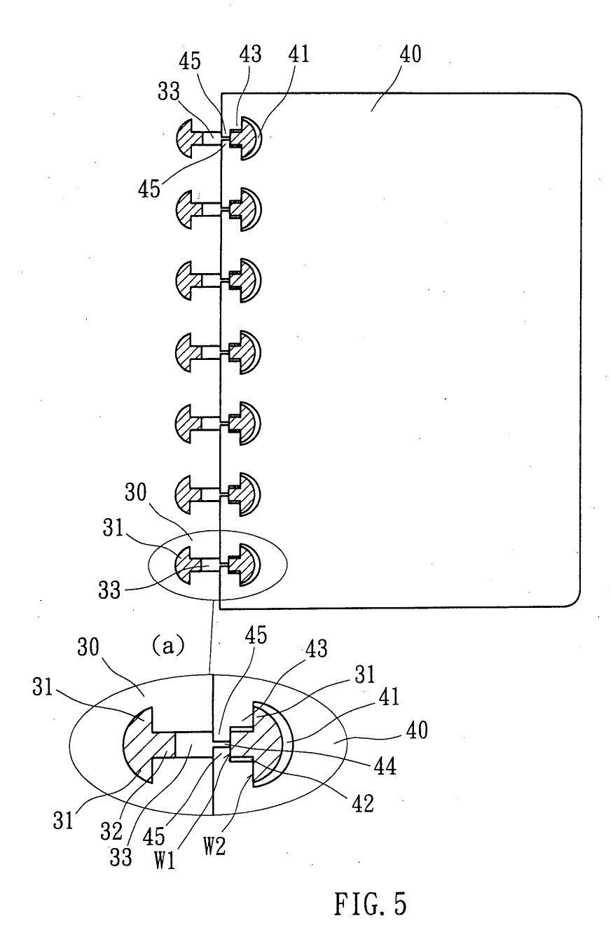

Referring to FIGS. 4 and 5, the present invention includes a plurality of sheets of papers 40, and a plurality of assembly units 30. Each assembly unit 30 has a round shape and a periphery of each assembly unit 30 has an annular ring 31. Each paper 40 has a plurality of through holes 41 and slots 42. Each through hole 41 and each slot are correspondent to the annular ring 31 of the assembly unit 30.

A center of the assembly unit 30 has a via hole 33 and an inner ring 32 is protruded from an inner wall of the annular ring 31.

Each slot 42 of the paper 40 is communicable to the outer side of the paper 40 by a slit 44. Thereby, inner buckles 43 are formed at the edges of the slot 42 and outer stoppers 45 are formed at the edges of the slit 44. In assembly the assembly unit 30, the outer stopper 45 is in the via hole 31 of the assembly unit 30 and the inner buckles 43 resist against inner sides of the annular ring 31 of the assembly unit 30.

In use of the present invention, the slots 44, slots 42 and through holes 41 of the paper 40 are embedded into the annular rings 31 and the inner rings 32 of the assembly units 30 so that the inner buckles 43 and the outer stoppers 45 of the paper 40 are buckled to the assembly units 30. A plurality of papers 40 are assembled by the assembly units 30 by above mentioned way so as to form a loose leaf book 30. When one of a paper is to be drawn out, the paper can be pulled upwards or downwards, then the inner buckles 43 and outer stoppers 45 separate from the slots 42 and slits 44, then the paper can be taken out.

Advantages of the present invention will be described here. Referring to FIG. 5, an enlarged view of the present invention is illustrated. In assembling the paper 40 with the assembly unit 30, the inner buckles 43 are buckled to the inner side of the annular ring 31 so as to form a buckle tip W2. The outer stoppers 45 are buckled to the via hole 33 of the inner ring 32 so as to form another buckle tip W1. When a force is applied to tear the paper 40, the force is applied to the buckle tips W1 and W2 instead on the connections of the inner buckles 43 and the through holes 41. Thus the stress is distributed so that the paper 40 has a larger tolerance.

By the buckling effect of the outer stoppers 45 and the slits 44, the buckling effect is enhanced.

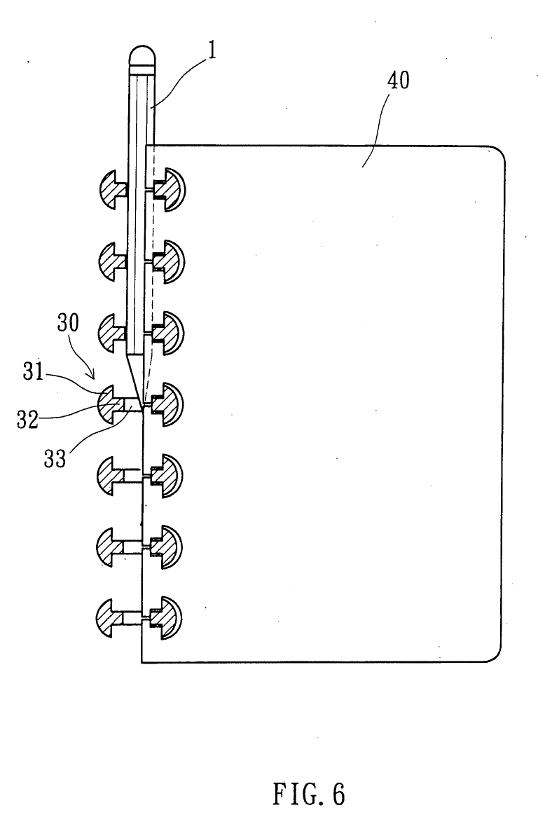

The assembly unit 30 has the via hole 33. Thereby, as shown in FIG. 6, the via hole 33 can be inserted by a pen 1 and thus a pen can be positioned on the loose leaf. Thus the pen will not lose.

The assembly unit 30 has a via hole 33 and thus the material used is reduced and the loose leaf is light.

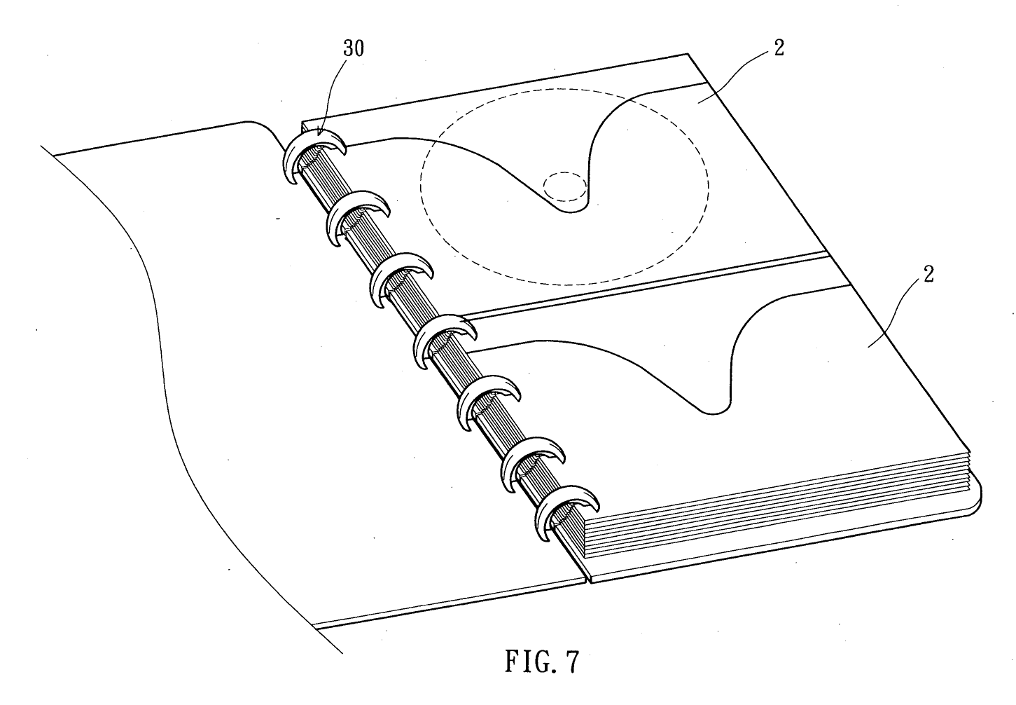

With reference to FIG. 7, in another embodiment of the present invention, the paper 40 is replaced a plurality of thin pocket sheets, each sheet can receive photographs, compact disks, etc.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. to 4. (Cancelled)

5. A loose leaf device comprising
a plurality of assembly units; each assembly unit having a round shape, each assembly unit having an annular ring portion formed peripherally thereon; each assembly unit having an inner ring protruding radially inward from an inner wall of the annular ring portion to extend about an axially open via hole;
a plurality of stacked sheets, each sheet having a plurality of through holes and slots formed thereon; each through hole and each slot being configured to receive therein the annular ring portion and inner ring of one assembly unit; each sheet having formed through a peripheral edge portion thereof at least one slit communicating with and extending from one of the slots, the sheets defining about each slot and each slit respective first and second stopping surfaces for respectively engaging the annular ring portion and inner ring of at least one assembly unit;
wherein each through hole is has a semi-round shape with a flat side; the slot extends from the flat side of the through hole; one side of the slot has a flat side; the slit extends from the flat slid of the slot; one end of the slit is communicated to the slot and another end of the slit is an opening which causes the slit to communicate with outside; a size of the annular ring portion is larger that a size of the slot; and a size of the inner ring is larger than a size of the a slot;
wherein after assembly of the sheets to the assembly units, the peripheral edge portion of the sheets are at least partially disposed in the via holes of the assembly units, and the inner rings of the assembly units engage the slot thereof so that an annular ring portion is located in a respective one of the plurality of through hole; and
wherein the via holes are each formed at a center of one assembly unit for receiving a pen.

6. A loose leaf device comprising
a plurality of assembly units; each assembly unit being endless and having a round shape, each assembly unit having an annular ring portion formed peripherally thereon; each assembly unit having an inner ring protruding radially inward from an inner wall of the annular ring portion to extend about an axially open via hole;
a plurality of stacked thin pocket sheets, each thin pocket sheet having a plurality of through holes and slots formed thereon; each through hole and each slot being configured to receive therein the annular ring portion and inner ring of one assembly unit; each thin pocket sheet having formed through a peripheral edge portion thereof at least one slit communicating with and extending from one of the slots, the thin pocket sheets defining about each slot and each slit respective first and second stopping surfaces for respectively engaging the annular ring portion and inner ring of at least one assembly unit;
wherein each through hole is has a semi-round shape with a flat side; the slot extends from the flat side of the through hole; one side of the slot has a flat side; the slit extends from the flat slid of the slot; one end of the slit is communicated to the slot and another end of the slit is an opening which causes the slit to communicate with outside; a size of the annular ring portion is larger that a size of the slot; and a size of the inner ring is larger than a size of the a slot;
wherein after assembly of the thin pocket sheets to the assembly units, the peripheral edge portion of the sheets are at least partially disposed in the via holes of the assembly units, and the inner rings of the assembly units engage the slot thereof so that an annular ring portion is located in a respective one of the plurality of through hole; and
wherein the via holes are each formed at a center of one assembly unit for receiving a pen.
